(19) United States
(12) Patent Application Publication
(10) Pub. No.: US 2024/0123687 A1
(43) Pub. Date: Apr. 18, 2024

(54) METHOD OF OPERATION FOR AN APPARATUS FOR LAYER-BY-LAYER MANUFACTURE OF 3D OBJECTS

(71) Applicant: Stratasys Powder Production Ltd., London (GB)

(72) Inventors: Gianluca Dorini, London (GB); Christoffer Raad Petersen, London (GB); Anders Hartmann, London (GB); David Armand, London (GB)

(21) Appl. No.: 18/484,643

(22) Filed: Oct. 11, 2023

(30) Foreign Application Priority Data
Oct. 13, 2022 (GB) 2215119.5

(51) Int. Cl. B29C 64/343; B29C 64/214; B29C 64/295; B29C 64/393; B33Y 10/00; B33Y 50/02

(52) U.S. Cl. CPC B29C 64/343; B29C 64/214; B29C 64/295; B29C 64/393; B33Y 10/00; B33Y 50/02

(57) ABSTRACT

A method of operating an apparatus for the layerwise manufacture of 3D objects. The method includes a warm up phase followed by a build phase. The phases each include a cycle of (a) dosing an amount of build material from a dosing device; (b) pushing a portion of the dosed amount across a build area into a receiving chamber; (c) heating the dosed amount at one or both of (a) and (b); repeating (a) to (c) until each phase is complete. During the build phase, at step (b) a layer is formed over the build area and, at step (c), build material within a layer-specific region is selectively melted. Over a given duration of time, an aggregate volume of build material pushed into the receiving chamber during the warm up phase is larger than an aggregate volume of build material pushed into the receiving chamber during the build phase.

### BACKGROUND

### 1. Field of the Invention

The present disclosure relates to a method of operation for an apparatus for the layerwise manufacture of three-dimensional (3D) objects from build material. The method might find particular benefit in a powder bed fusion apparatus in which cross sections of 3D objects are formed within successive layers of particulate material using thermal processing. A controller and an apparatus for applying the method are also disclosed.

### 2. Description of Related Technology

In applications for forming 3D objects from particulate material, such as powder bed fusion applications like “print and fuse” and laser sintering applications, an object is formed layer-by-layer from particulate material spread in successive layers across a support. An area within each successive layer is melted to fuse, or partially melted or sinter, the particulate material, in order to form a cross section of the 3D object. In the context of particulate polymer materials, for example, the process of melting achieves fusion of particles. Typically, several heating devices are operated in a print and sinter apparatus to heat the particulate material during each layer cycle. For example, one or more infrared bar heaters may be moved across each layer to heat the layer surface (the build area) sufficiently to achieve fusion over selectively modified regions. The thermal processes of the layer cycle require accurate control to achieve high-quality, uniform objects with well-defined properties in a reliable, reproducible manner.

At the start of a build process of an object, the apparatus typically is required to carry out a warm up process that ensures a steady thermal state at operational temperature has been reached for a stable environment for the build process. Such a warm up process may take a significant period of time of the overall process of operation to build an object. This problem may be exacerbated in certain recirculation-type apparatus, within which a portion of build material unused in the formation of each layer is directly returned to be reused again. Therefore, improvements to the warm up process are needed. The present invention provides improvements to the warm up process.

### SUMMARY

The invention is set out in the appended independent claims, while particular embodiments of the invention are set out in the appended dependent claims.

The following disclosure describes, in one aspect, a method of operation for an apparatus for the layerwise manufacture of 3D objects from particulate material, the apparatus comprising a build area arranged between a dosing device side and a receiving chamber side, a dosing device at the dosing device side configured to dose an amount of build material onto a work surface comprising the build area, and a receiving chamber configured to receive at least a portion of the dosed amount and to return the portion to the dosing device; wherein the method comprises a warm up phase followed by a build phase for one or more 3D objects, the warm up phase and the build phase comprising a cycle of the steps of (a) dosing the amount of build material from the dosing device onto the work surface; (b) pushing at least a portion of the dosed amount across the build area from a dosing device side to a receiving chamber side of the build area and into the receiving chamber; (c) heating the dosed amount at one or both of steps (a) and (b); wherein the steps (a) to (c) are repeated until each phase is complete; wherein the build phase further comprises at step (b): forming a layer over the build area from a layer portion of the dosed amount while pushing the dosed amount over the build area, and at step (c) a step of selectively melting the build material within a layer-specific region defined within the build area; wherein, over a given duration of time, an aggregate volume of the portions of build material pushed into the receiving chamber during the warm up phase is larger than an aggregate volume of the portions of build material pushed into the receiving chamber during the build phase.

In a second aspect, a controller configured to determine one or more properties of the warm up phase based on a predefined duration over which the warm up phase is to be applied to achieve a steady thermal state is also disclosed.

### BRIEF DESCRIPTION OF THE DRAWINGS

Reference is now directed to the drawings, in which:

FIG. 1 is a flow chart of the method according to the invention;

FIG. 2A is a schematic cross-section of a side view of an apparatus configured to apply the method according to the invention;

FIG. 2B is a schematic plan view of the build area of FIG. 2A;

FIG. 3 is a schematic cross-section through an example build material recirculation system suitable for the apparatus of FIG. 2A;

FIG. 4 illustrates an alternative system to the one of FIG. 3;

FIG. 5 illustrates, in a simplified variant in of FIG. 2 or 3, the location of a thermal sensor;

FIG. 6 is an alternative variant to that of FIG. 5;

FIG. 7 and FIG. 8 are flow charts of two variants of the warm up phase of FIG. 1; and

FIG. 9 schematically illustrates a temperature of the build material path during the warm up phase and build phase.

In the drawings, like elements are indicated by like reference numerals throughout.

### DETAILED DESCRIPTION

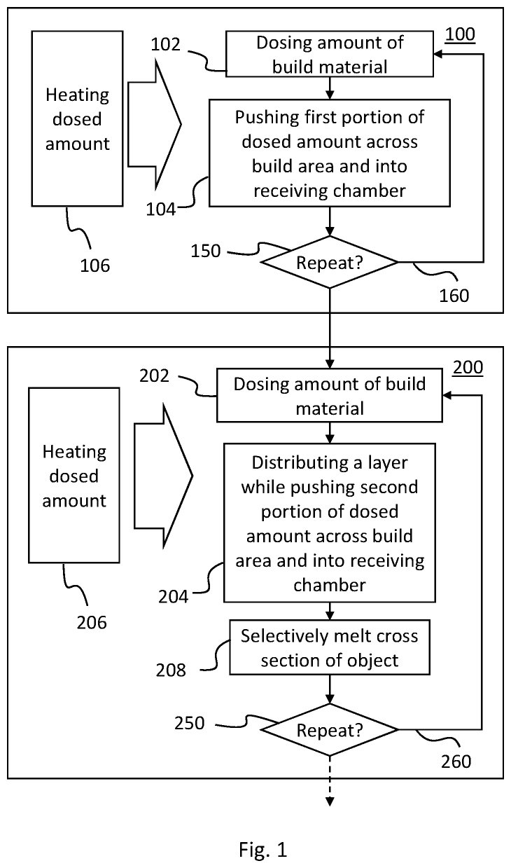

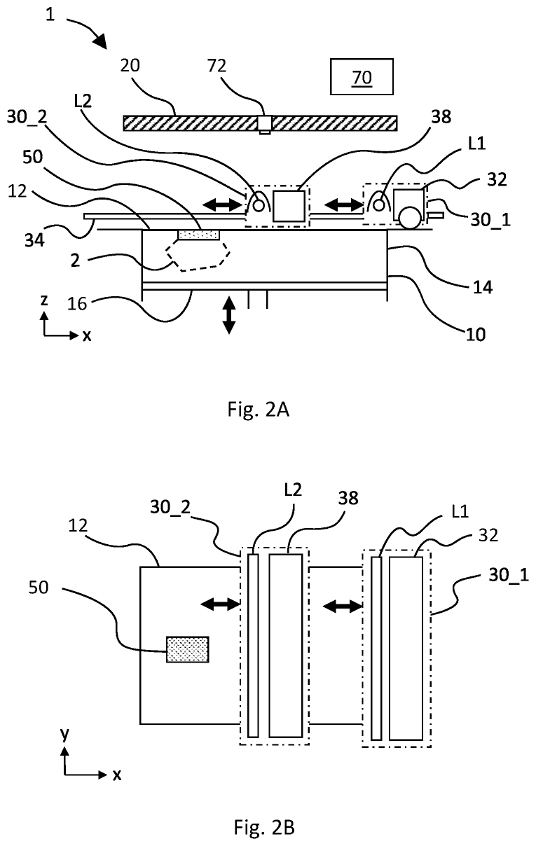

Turning first to FIGS. 2A and 2B, an example of a 3D printing apparatus in the form of a powder bed fusion type apparatus will be described, before turning to the method and its variants according to the invention that will be to be described with reference to FIGS. 1 to 9, and which the example apparatus is configured to carry out.

FIG. 2A is a schematic cross-section of a side view of a powder bed fusion type apparatus; and FIG. 2B is a schematic plan view of the build area of FIG. 2A. Herein, the powder or particulate material used in such apparatus will be referred to as “build material”. In a typical build phase for the layerwise formation of a 3D object from build material, successive layers of build material are distributed over a platform 16, each top-most surface representing a build area, or build bed surface 12, which is processed to form successive cross-sections of an object 2. In this context, each newly distributed layer forms a new build area 12 that is the build area of the layer to be processed in that particular layer cycle.

As indicated in FIG. 2A, the apparatus 1 comprises a distribution module 32 for distributing each layer of particulate build material across a support or build area 12, a deposition module 38 configured to selectively deposit absorption modifier to define a layer-specific region 50 within the build area 12, and a heating module comprising a fusing heat source L2 to achieve selective heating of the layer-specific region 50. The layer-specific region 50 may represent a cross section of an object 2 or a test region in a calibration process. The term “layer-specific region” indicates that its position, shape and pattern is layer dependent, and its purpose may be different for different phases of an operational phase of the apparatus. The modules may be provided on one or more carriages moveable across the layer. In the example of FIG. 2A, an implementation with two carriages 30_1 and 30_2 is shown. The carriages are arranged on one or more rails 34 that allow them to be moved back and forth over the build area 12 along a first direction, e.g. along x, and along a second direction opposite the first direction. The first carriage 30_1 in this variant comprises the distribution module 32, for example comprising a build material distributor or distributing device in form of a roller as shown. The second carriage 30_2 comprises the deposition module 38, such as a droplet deposition module configured to deposit the absorption modifier in the form of fluid droplets. Mounted behind the deposition module 38, with respect to the first direction, is the fusing heat source L2. Where the distribution module is a roller, a fresh portion of powder is dosed to a work surface 10 to the right of the roller and to the left of the build area 12, the work surface 10 comprising the build area 12, and the portion is spread over the build bed 14 as the roller is moved over the build area 12. Alternatively, the distribution module 32 may contain particulate material that is gradually released and spread over the build area 12 as the module is moved over the build area 12. The build bed 14 is contained between walls 8 and supported on a platform 16, which is arranged to move vertically within the container walls 8 to lower or raise the build area 12; for example by a piston located beneath the platform 16. As will be described in more detail below, the apparatus further comprises a dosing device to supply a dosed amount of build material to be distributed across the build bed 14, thus forming a new build area 12.

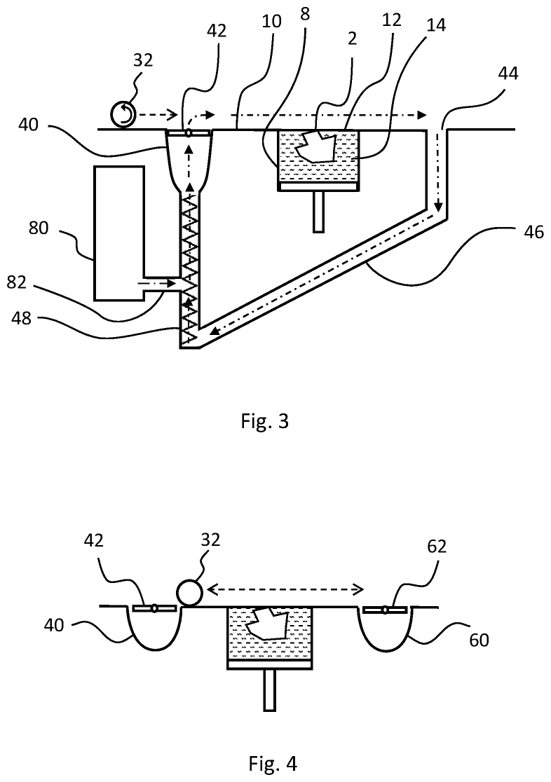

FIG. 2B shows a plan view of the build area 12 of FIG. 3A with the layer-specific region 50 and the carriages 30_1 and 30_2 with the distribution, deposition and heating modules spanning the width of the build area 12 (along y). As indicated before, each carriage 30_1, 30_2 is moveable back and forth along the x-axis, which herein is also referred to as the length of the build area 12, the length being perpendicular to the width, however reference to length and width is not intended to indicate relative extent of the two directions but to merely help reference directions of the process.

The absorption modifier may be radiation absorber deposited over the layer-specific region 50, and/or absorption inhibitor deposited over a surrounding area surrounding the layer specific region 50. Selectivity of preferentially heating the layer-specific region 50 versus the surrounding area is achieved by providing a fusing heat source L2 with a spectrum of radiation that is absorbed to a higher degree by the radiation absorber compared to the surrounding area. If the combination of absorber and power input to the fusing heat source L2 (causing a certain energy input to the region 50) is sufficient, the build material of the layer specific region 50 partially melts (sinters) or melts fully to form a region of consolidated build material. Thus, during a build phase of an object, the radiation absorber may be deposited over layer-specific regions 50 of the build area 12 so that layer-specific cross sections of the object 2 may be formed within successive layers.

During a typical build phase, the build area 12 is maintained at or close to a predefined target layer temperature that is below the melting temperature of the build material and above the solidification temperature. This means it may for example be maintained within a temperature range of 10-20° C. below the melting temperature. The fresh particulate material dosed to the work surface 10 to be distributed across the build area 12 is generally at a significantly lower temperature for example 40° C. or more below the melting temperature, such that the distributed layer has a significant cooling effect on the build area 12 of the previous layer. Such large temperature differentials can cause warping of the fused parts, such that it is desirable to increase the temperature of the distributed layer to, or closer to, the target layer temperature of the build area 12 without unnecessary delay. Therefore, it is desirable that the dosed build material is already at an elevated temperature chosen to be below the glass transition temperature of the material for example and a thermal degradation temperature. This may be achieved by heating for example at least part of the dosing device, for example the retaining walls of the dosing device retaining build material ready to be dosed, to a predefined temperature throughout the operation of the apparatus. A supply tank suppling the dosing device with build material may be heated additionally or instead. In addition, a further heat source, such as a heat source L2, as indicated in the apparatus 1 of FIGS. 2A and 2B, may be provided behind the distribution module 32 on the second carriage 30_2 to immediately preheat the freshly distributed build material further, to a temperature closer to the target layer temperature.

The two heat sources will be referred to with respect to the order in which they heat each layer; thus the preheating heat source L1 following the distributor is herein also referred to as “first heat source”, L1, and the fusing heat source following the deposition module, and typically used to fuse the particulate material of the layer specific region during a build process, is referred to as “second heat source”, L2. The wavelength spectrum of the first heat source L1 is such that, over a preheat period of time, it is capable of sufficiently preheating the layer-specific region 50 and the surrounding area, both being void of radiation absorber, up to or towards the target layer temperature. The target layer temperature may be achieved in combination with, for example, operating an overhead heater 20 provided stationary above the build area 12 as shown in FIG. 2A. As for the second heat source L2, the period of time over which the second heat source L2 heats the layer specific region 50 may be determined by the speed at which the first heat source L1 traverses, and transfers heat to, the layer-specific region 50.

The build area 12 may be monitored by a thermal sensor 72 provided above the build area 12. The thermal sensor 72 may be a thermal camera or a pyrometer within the area of the overhead heater 20 and centrally mounted above the build area 12, or it may be provided on one or both of the carriages 30_1, 30_2 in the form of a thermal line scan sensor. The measurements from the thermal sensor 72 may be used to apply feedback control to one or more of the heating devices involved in heating the build area 12, for example to the overhead heater 20. When the overhead heater 20 is adequately controlled, via a controller 70, local differences in temperature across the build area 12 may be reduced, which may improve object quality by enhancing control over mechanical and visual object properties.

Adequate control requires thermal stability of the apparatus before the build phase is started. Furthermore, in order to repeatably form layers of highly uniform thickness, the dosed build material preferably comprises a surplus amount to forming the layer. This ensures that each layer is fully formed. The dosed amount in a recirculation system may thus be chosen to comprise a sufficiently surplus ‘portion’ to ensure that no “short feed”, in the form of unintentionally thinner or missing areas of the layer, occurs. Thus a uniform layer thickness may be achieved repeatably. The surplus amount may be handled efficiently by returning it to the dosing device during normal operation within the apparatus, without having to remove, treat and return the surplus material from and to the apparatus. Preferred variants of the apparatus 1 may thus comprise build material systems that automatically recirculate the surplus build material back to the dosing device in situ and thus allow efficient reuse of the surplus build material. Examples of such in situ recirculating systems will now be described with reference to FIGS. 3 and 4, which are schematic cross sections through the recirculating supply path of two alternative arrangements that may be provided within the apparatus of FIG. 2A.

FIG. 3 illustrates a first variant of an in situ recirculation path, in which the path is indicated by dotted-dashed arrows. Build material is supplied to a dosing device, in the form of a dosing chamber 40 arranged below the work surface 10 comprising the build area 12, from a supply tube 48. The supply tube comprises a lifting device such as an auger conveyor. The supply tube 48 is fed from a supply tank 80 connected to the supply tube via a tank connection 82. From the dosing chamber 40, a dosed amount of build material is provided to the work surface 10 through an opening in the work surface by a rotating blade 42, the rotating blade 42 arranged to pick up the dosed amount from the build material in the dosing chamber 40 and deliver it to the surface, for example by temporarily being level with the surface 10 (as shown) while holding the dosed amount above it until the distributor 32 has passed. To form a layer over the build area 12, the platform 16, supporting the build volume 14 within container walls 8, is lowered by a layer thickness so as to form a recess within the build container walls 8 and the build area 12. After dosing the build material to the surface 10, the distributor 38 is passed over the surface 10 along the direction of the dashed arrow to push the dosed amount across the build area 12. As the dosed amount is pushed across the build area 12, a layer portion of the dosed amount fills the recess formed within the build container walls 8 and the build area 12, thus forming a fresh layer with a new build area 12. The remaining portion of the dosed amount that is not used to form the new layer, referred to herein as the “portion” of the dosed build material, is pushed into a recirculation opening 44 to be returned to the supply tube 48 via a recirculation tube 46. By arranging the connections between the tubes as shown, the surplus portion of build material is fed into the supply tube and returned to the dosing chamber before fresh build material is drawn from the tank 80. Such a recirculation system is thus arranged to efficiently reuse the surplus portion of the dosed amount of build material. Variants of such a recirculating system may include a dosing device that feeds build material from above the build bed surface, supplied by an overhead tank to the dosing device and that is configured to receive and mix fresh build material from a fresh build material tank with build material returned from the receiving chamber. Such a recirculating system may be configured to transport the build material with one or more powder pumps.

An alternative recirculation system is shown in FIG. 4. In this system, a second dosing chamber 62 is provided in place of the recirculation opening 44 in FIG. 3. In this system, the distributor may push a dosed amount dosed to the work surface 10 by the dosing blade 42 across the build area 12 from left to right, as described with respect to FIG. 3, and push the surplus portion into the second dosing chamber 60 (for example, the second dosing blade 62 may be rotated as the distributor passes so as to create an opening). Next, the second dosing blade may rotate to dose a further dosed amount to the work surface 10; the piston may be lowered to create a recess to receive a further layer. In a similar way as described above, but in the opposite direction from right to left, the distributor passes across the build area 12 to form a further layer from the further dosed amount, and to push the remaining portion into the first dosing chamber 40. In this variant, the dosing chamber 40, 60 is also a receiving chamber 40, 60. One or both dosing chambers 40, 60 may be supplied with build material via supply tubes 48, comprising auger conveyors for example, from one or two tanks 80. Such as system is therefore also arranged to efficiently reuse the surplus portion of the dosed amount of build material. To ensure thermal stability before a build phase, the build material within the supply system is brought to a stable temperature above ambient temperature, which is a temperature at which the apparatus is at the thermal state of its surroundings and may be referred to the ‘cold’ thermal state. Thermal stability before the build phase may be represented by achieving respective thermal equilibrium along various locations of the build material path of the build material, wherein the build material path may comprise the conveyance path along which the build material is moved and may comprise the path from dosing from a dosing chamber 40 to a work surface 10, distributing over a platform 16 or build area 12, and recirculating the build material back to the dosing chamber. The temperature representing the stable thermal state may be location dependent with regard to locations of the build material path, i.e. may not be represented by the same temperatures. For example, the build material in the dosing chamber is typically at a lower temperature than the build area, and may thus be at a lower thermal state than the build area. Thermal stability before the build phase may be achieved by e.g. heating to a stable temperature the build material within the supply pipes and/or dosing chamber to 30-90° C. below the melting temperature of the build material. For polyamide PA11, which has a melting temperature of around 190° C., this may be a temperature from 100° C. to 160° C. The build area 12 may be required to achieve a thermal state at a higher temperature, closer to but below the melting temperature, at for example a target layer temperature of around 180° C.

It is desirable to reach a stable thermal operational state at predefined warm up temperatures of the build material path within an acceptable time for an industrially viable manufacturing process requiring high throughput of objects. Thus an improved method of operation for apparatus comprising a build material recirculation system as described is provided. According to the invention and with reference to the flow chart of FIG. 1 and FIGS. 2A to 4, and wherein the apparatus comprises a build area 12 arranged between a dosing device side and a receiving chamber side; a dosing device 40, 60 at the dosing device side configured to dose an amount of build material onto a work surface 10 comprising the build area 12; and a receiving chamber 44, 60 at the receiving chamber side configured to receive at least a portion of the dosed amount and to return the portion to the dosing device 40, the method comprises:
a warm up phase at block 100 followed by a build phase for one or more 3D objects at block 200, the warm up phase at block 100 and the build phase at block 200 comprising a cycle of the steps of:
(a) dosing the amount of build material from the dosing device 40, 60 onto the work surface 10 as illustrated by block 102;
(b) pushing at least a first portion of the dosed amount across the build area 12 from a dosing device side to a receiving chamber side of the build area 12 and into the receiving chamber 44, 60 as illustrated by block 104; and
(c) heating, at one or both of steps (a) and (b), the dosed amount, as illustrated by respective phase blocks 106 and 206; wherein the steps (a) to (c) are repeated until the warm up phase 100 is complete as indicated at blocks 150 and the cycle loop 160 for the warm up phase, and at blocks 250 and the cycle loop 260 for the warm up phase.

The build phase 200 further comprises the steps (a) to (c) as illustrated by blocks 202 and 204, and further comprises, as illustrated by block 204, forming at step (b) a layer over the build area 12 from a layer portion of the dosed amount, while pushing a second portion of the dosed amount over the build area 12 and into the receiving chamber 44, 62, and at step (c) heating so as to selectively melt or sinter a layer specific region 50 defined within the build area 12 at block 208. The cycle of the build phase 200 is repeated from blocks 202 to 208 until the object is complete, as indicated at blocks 250 and the cycle loop 260. After completion of the object, a cooling process may be applied, as indicated by the dashed arrow.

The respective dosed amounts of the warm up phase 100 and the build phase 200 and/or the first and second portions are chosen such that, over a given, same duration of time, the aggregate volume of the first portions of build material pushed into the receiving chamber 44, 60 during the warm up phase 100 is larger than the aggregate volume of the second portions of build material pushed into the receiving chamber during the build phase 200. This may be achieved in various way which will be described below.

Heating the Dosed Amount

The various ways in which the dosed amount at block 106 may be heated may comprise: (c1) heating the build material in the dosing device, e.g. dosing chamber 40 (and optionally the second dosing 60 of FIG. 4) chamber at block 102 during the warm up phase 100, and optionally also during the build phase 200. Heating the dosed amount may for example comprise heating a wall of the dosing chamber 40, 60 so as to heat the build material surface inside the dosing chamber, by applying foil heaters to the outer surfaces of thermally conductive dosing chamber walls.

Additionally, or instead, a heat source arranged at least intermittently positioned above the dosing chamber 40 may be operated to heat the build material inside the dosing chamber 40, 60. The dosing chamber may be arranged below the work surface 10 as shown in FIGS. 3 and 4, and may thus comprise an opening to the work surface, and the heat source may be configured to radiate through the opening at least intermittently. For example, one of the movable heat sources L1, L2 may be positioned temporarily above the opening with the dosing blade 42, 62 in the vertical position so that the radiation may reach into the dosing chamber 40. In a further variant, heating the dosed amount may comprise heating at least part of a build material path between the receiving chamber 44 and the dosing chamber 40 so as to heat the portion of build material as it is being returned to the dosing chamber 40. With reference to FIG. 3 for example, any one or any combination of the tubes conveying the build material from the receiving chamber (the recirculation opening 44) back to the dosing chamber 40 may be heated: the recirculation tube 46, the supply tube 48, the tank connector 82, and/or the tank 80. Furthermore, or instead, heating the dosed amount at block 106 may comprise: (c2) heating the surplus portion of the dosed amount as it is being pushed across the build area 12. This may comprise, for example, heating the build area 12 by one or more of: (i) operating a stationary heat source, such as overhead heater 20, arranged above the build area 12; (ii) operating one or more moveable heat sources while passing the one or more moveable heat sources across the build area 12, such as the moveable preheat and fuse heat sources L1 and L2 described with reference to FIGS. 2A and 2B. Furthermore, the second, or fusing, radiative heat source L2 moveable across the build area 12 may be provided to heat the dosed amount, for example by travelling ahead of the distribution device 32 while irradiating and heating the dosed amount as it is being pushed in front of the distributor over the build area. The spectrum of the fusing heat source may be such that it causes warming of the build material in absence of absorber, and only causes fusion in the presence of absorber. In other words, during the warm up phase, both the preheating and fusing heat sources (in the absence of radiation absorber) may be operated to heat the build material without causing fusion.

The dosed amount may thus be heated during part or all of the warm up phase 100. Some of the variants of the method in which the dosed amount may be heated may apply to part or all of the warm up phase 100 and not to the build phase 200, so as to apply additional heat to the warm up phase compared to the build phase. During some or all of the warm up phase 100, additional thermal components may be applied to heat the dosed amount, or may be operated differently, compared to the build phase 200, thus applying a different thermal cycle during the warm up phase compared to the build phase. In preferred variants described below, once the warm up phase 100 achieves a certain predefined warm up target temperature or has completed a predefined number of cycles, it may progress to a different operational mode that is alike to that of the build phase. This ensures that the same thermal cycle is maintained when transitioning from the warm up phase 100 to the build phase 200. It has been found that this provides improved consistency in the quality of the built objects.

Furthermore, or instead, the heat output and/or radiative wavelength of the one or more heat source(s) L1, L2 may be different during at least part of the warm up phase 100 compared to the build phase 200 so as to achieve different levels of heating of the dosed amount during the warm up phase 100 compared to for example heating the layer or object specific region 50 during the build phase. Further still, the one or more moveable heat sources L1, L2 may be operated while passing each across the build area, wherein the steps of distributing and passing while operating the one or more moveable heat sources may be carried out in the same direction across the build area 12. This may provide for additional thermal uniformity and may preferably be applied in the same way during the warm up phase 100 and the build phase 200. Optionally, the dosed amount by be heated by operating a heater (not shown) arranged below the build area 12 so as to heat the build area 12. For example, the platform 16 may be heated so as to heat the build area 12 from below.

In order to determine when to complete the warm up phase, for example whether the predefined warm up temperature has been achieved, the method may further comprise measuring a temperature of the build material in the dosing chamber 40; heating the build area 12 in response to the measured temperature and with respect to the predefined warm up temperature, plateau temperature Tₚₗₐₜₑₐᵤ; and completing the warm up phase 100 upon determining at block 150 that the plateau temperature Tₚₗₐₜₑₐᵤ has been reached.

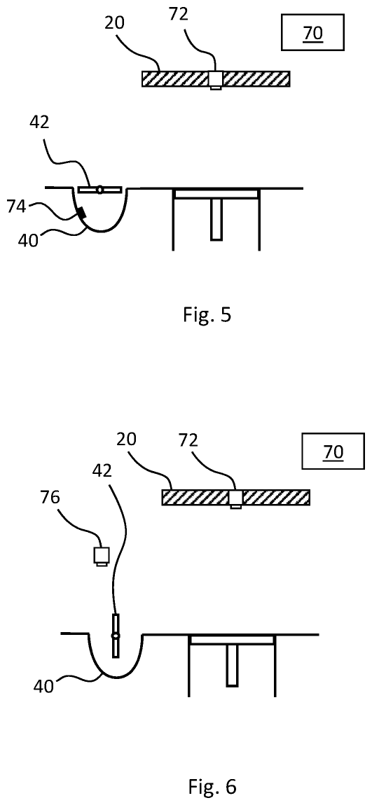

FIG. 5 exemplifies a variant of a dosing chamber 40 in a simplified schematic cross section of FIGS. 2A to 4, to which a thermal wall sensor 74 is mounted to one of the side walls. Measuring the temperature of the build material in the dosing chamber 40 may thus comprise sensing a temperature of the build material in proximity to the thermal wall sensor 74 in the dosing chamber. Alternatively, as shown in an alternative to FIG. 5 in FIG. 6, a remote thermal sensor 76 such as a pyrometer may be provided above the opening of the dosing chamber 40, arranged to measure the temperature of the surface of the build material inside the dosing chamber 40 when the dosing blade 42 is in the vertical position during its rotation. Measuring the temperature of the build material in the dosing chamber 40 may thus comprise measuring the temperature of the surface of the build material within the dosing chamber 40 (and/or within the second dosing chamber 60) using a remote thermal sensor 76 arranged to view the surface of the build material at least intermittently. For an overhead dosing device, a thermocouple may be mounted to a wall of the dosing device, such as an interior wall, or to a wall of the mixing tank that supplies the dosing device.

In some variants, which comprise apparatus in which the distributor may be heated, for example heating the roller shown in FIG. 2A, the dosed amount may be heated, or further heated, through being in contact with it while it is being pushed across the build area 12. The method may thus comprise, or further comprise, at least for the warm up phase 100 at block 104, heating the distributor 32, and passing the heated distributor 32 across the build area 12, the heated distributor pushing the portion of the dosed amount across the build area 12 while heating the dosed amount through being in contact with it; pushing the surplus portion into the receiving chamber 44, and returning the distributor 32 to the dosing chamber side before the next cycle starts at block 102. In variants, the method may comprise, during at least the warm up phase 100, passing the distributor 32 across the build area 12 and operating a heat source arranged to pass across the build area ahead of the distributor and configured to irradiate the portion of build material while it is being pushed across the build area 12. The heat source may be an additional heat source mounted in front of and moving with the distributor 32 and may be operated only during the warm up phase; or in apparatus in which the position of the carriages is reversed, it may be the fusing heat source L2 operated during both the warm up phase and the build phase but potentially at different heat outputs.

Surplus Aggregate Volume Larger in Warm Up Phase

In order to achieve a shorter duration of a warm up phase by departing from the thermal cycle of the build phase 200, a larger aggregate volume of surplus portions of build material is pushed into the receiving chamber during the warm up phase 100 compared to the build phase 200 over a given duration of time. Compared to the build phase 200, this may be achieved by changing the thermal cycle, by arranging the dosed amount to be larger in volume, and/or passing the distributor 32 at a higher speed across the build area 12. Where the dosed amount remains the same during the warm up phase and the build phase, operating the distributor at a higher speed of pushing the dosed amount and/or returning the distributor along the opposite direction over the build area before dosing the next amount, the aggregate volume of the portions of build material pushed into the receiving chamber 44, 60 during the warm up phase 100 is larger than that during the build phase 200 over the given duration of time. In both cases, more heated surplus volume is recirculated through the recirculating system to allow it to reach the plateau temperature Tₚₗₐₜₑₐᵤ sooner compared to a heated surplus volume that would results if the build phase were to be applied. The thermal state may be determined with respect to the plateau temperature Tₚₗₐₜₑₐᵤ defined to be closer to the preheat temperature, for example as measured by a wall sensor mounted to the dosing chamber wall. It also means that over a given duration of time, the aggregate volume of the portions of build material pushed into the receiving chamber during the warm up phase is larger than the aggregate volume of the portions of build material pushed into the receiving chamber during the build phase. Herein, references to “above” and “below” with respect to thermal state are intended to refer to a respective higher or lower temperature determined at one or more representative locations of the build material path to measure or indicate the temperature of the build material. For example, the thermal state determined from a temperature of the build material measured within the dosing chamber 40 may be lower after a short cool down period than the thermal state determined by the same sensor after initiation of the warm up phase or build phase. The lower temperature may thus be used to represent a reduced thermal state compared to that determined after initiation of the warm up phase or build phase.

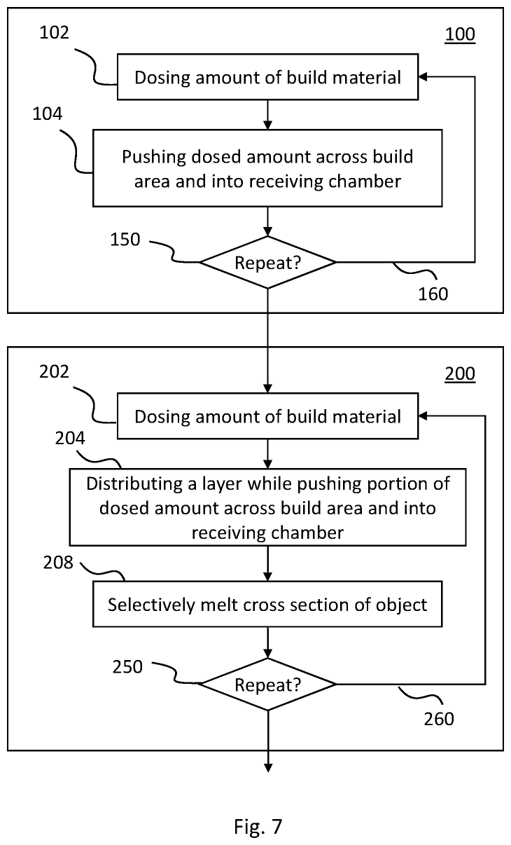

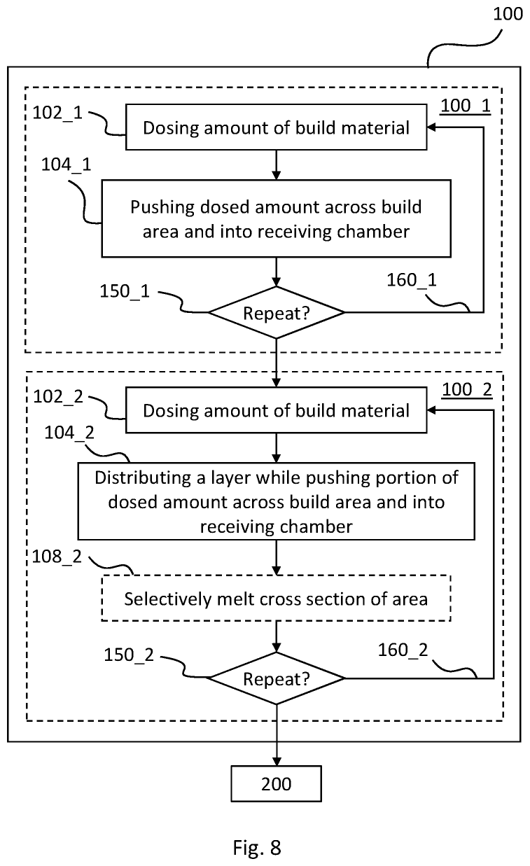

Non-layering and Layering Stages of Warm Up Phase; FIGS. 7, 8

The warm up phase may at least partially comprise a non-layering, initial warm up stage wherein the build area 12 is not lowered before block 104, such that substantially no layer of build material is formed across the build area 12 from the dosed amount, and such that the portion pushed into the receiving chamber is substantially the dosed amount, or a maximum amount of the dosed amount without forming a layer. This is illustrated with reference to FIG. 7, which is a flow chart of a variant of the method of the invention: the step at block 104 involves pushing the entire dosed amount across the build area 12 and into the receiving chamber without forming a layer; and repeating the cycle of blocks 102 and 104 while heating the dosed amount at a block 106 at one or both of blocks 102 and 104 (not shown but applying equally as shown and described for FIG. 1). Heating the dosed amount may be achieved in one or any combination of the various ways described herein. In this way a larger volume of heated surplus build material is recycled through the recirculation system to warm up the build material in the dosing chamber and thus along the build material path. The warm up phase is applied for a number of cycles determined at decision point 150 and along loop 160. The non-layering stage may be repeated until a predefined non-layering target temperature T_{NLS}, has been reached as determined at decision point 150. This may be measured in relation to the build material inside the dosing chamber 40, for example by the temperature sensor 74 mounted to the wall of the dosing chamber 40 in FIG. 5 or the remote thermal sensor 76 in FIG. 6. Alternatively, the non-layering stage may comprise a predetermined number of cycles.

In a preferred variant illustrated in FIG. 8, which is a variant of FIG. 1, the warm up phase 100 comprises a non-layering stage 100_1 followed by a layering stage 100_2 before proceeding to the build phase 200. The blocks 106, 206 of heating the dosed amount is not shown in FIG. 8 but equally applies as described above. As discussed with reference to FIGS. 2A and 2B, at least during the build phase 200, before step (b) at block 204 each layer may be formed by lowering the build area 12 by a build distance to form a build recess within the work surface 10, such that a build layer portion of the dosed amount fills the build recess to form the build layer of a build thickness defined by the build distance. The layering stage of the warm up phase 100 may also comprise, before block 104, lowering the build area 12 by a warm up distance to form a warm up recess within the work surface 10, such that a warm up layer portion of the dosed amount fills the warm up recess to form a warm up layer of a warm up thickness defined by the warm up distance. This is indicated in FIG. 8 at block 104_2, and the layering stage 100_2 comprises equally, before block 104_2, lowering the build area 12 by a warm up distance to form a recess within the work surface 10, such that a layer portion of the dosed amount fills the recess to form the warm up layer of a warm up thickness defined by the warm up distance. The warm up distance may for at least some of the layering stage 100_2 be smaller than the build distance such that at least some of the warm up layers are thinner than the build layers. Preferably, before transitioning to the build phase 200, the warm up layer thickness is the same as that of the build layers so as to transition with a stable thermal cycle. Thus, during at least a final part of a layering stage 100_2 of the warm up phase, the warm up distance may be the same as the build distance, such that the layer portion is the same for the layering stage 100_2 and the build phase 200. Optionally, during some or all of the layering stage 100_2 of the warm up phase 100, the dosed amount of the warm up phase 100_2 may be larger than the dosed amount of the build phase 200; and/or the speed of pushing the dosed amount over the build area 12 may be higher during the warm up phase 100 than during the build phase 200.

In variants of the method, the warm up phase 100 may not comprise a non-layering stage. In some variants, the warm up phase 100 may comprise, or consist only of, a layering stage, during which for at least some of the cycles, the thermal cycle is different to that of the build phase, for example by varying the amount of heating of the dosed amount. In some variants this may be done in combination with forming thinner layers during at least part of the warm up phase compared to the build phase 200. Thus the warm up phase 100 may comprise a warm up stage with a different thermal cycle to the build phase, followed by a warm up stage with the same thermal cycle as build phase; wherein the different thermal cycle may be achieved by one or more of varying the speed of the distributor, of the moveable heat source(s) and/or of the thermal outputs of the heat sources. This reduces the overall duration of the warm up phase 100 while providing at a transition to the build phase 200 a stable thermal (layering) cycle that is the same as that of the build phase.

The warm up phase 100 may progress from the non-layering stage 100_1 to the layering stage 100_2 when a temperature measured of the build material, for example within the dosing chamber, has reached a predefined temperature. The predefined temperature may be the non-layering stage target temperature T_{NLS} as measured by the dosing chamber wall sensor 74 or the remote sensor 76. During the layering stage 100_2, the thermal sensor 72 located above the build area 12 may be used in addition to measure the temperature of the build area 12. The method may progress to the build phase 200 once a measured temperature, for example Tₚₗₐₜₑₐᵤ as measured by the dosing chamber wall sensor 74 or the remote sensor 76, indicates that a steady thermal state has been reached and a steady target layer temperature T(target) may be achieved during the build phase 200. By progressing based on thermal sensor feedback between blocks 100 and 200, or between blocks 100_1, 100_2 and 200, the number of cycles each stage or phase has to complete can be tailored efficiently to different starting temperatures at the start of the warm up phase and may minimises the duration of the warm up phase. Alternatively, the number of cycles of the non-layering and/or the layering phase may be predetermined and applied in the same way before each build phase irrespective of the starting temperature of the warm up phase 100.

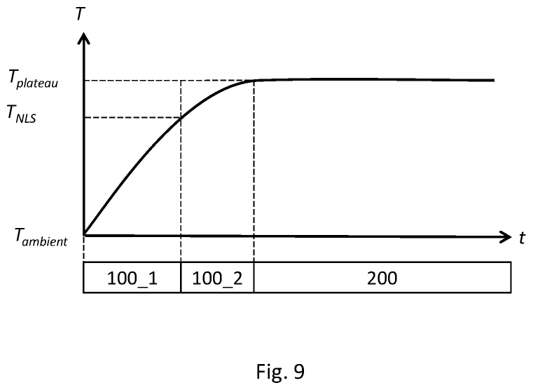

A temperature curve which schematically illustrates temperature of the build material inside the dosing chamber as measured by the dosing chamber wall sensor 74 or the remote thermal sensor 76 is shown in FIG. 9. A similar shape of curve may be measured at different one or more locations of the build material path. As illustrated in FIG. 9, during the warm up phase comprising of a non-layering stage 100_1 and a layering stage 100_2, the temperature rises from an initial ambient temperature T_{ambient} to a stable steady state temperature Tₚₗₐₜₑₐᵤ Once Tₚₗₐₜₑₐᵤ has been reached, it may be predetermined that at or near the end of the warm up phase 100, the temperature of each layer repeatably reaches a stable target layer temperature T(target) as measured by a remote sensor 72 arranged above the build area 12. The target layer temperature in this case is represented by or based on stable steady state temperature Tₚₗₐₜₑₐᵤ, which may be represented by or based on a steady temperature of the build material achieved in the dosing chamber, as measured by the wall sensor 74 or the remote thermal sensor 76. The steady temperature is indicated as Tₚₗₐₜₑₐᵤ. The actual target layer temperature T(target) may be measured and monitored additionally during the layering stage of the warm up phase using a thermal sensor 72 located above the build area 12. In FIG. 9, the non-layering stage 100_1 is applied until a predefined non-layering stage target temperature T_{NLS} is reached. After this, the layering stage 100_2 is applied, during at least the final part of which the thermal cycle is preferably the same as that of the build phase so as to ensure a smooth transition to the build phase 200. A predefined number of final layers may be defined as part of the layering stage that are to be processed once Tₚₗₐₜₑₐᵤ has been achieved. It will be apparent to the skilled person that, where different sensors are used to determine the plateau temperature of the material in the dosing chamber, Tₚₗₐₜₑₐᵤ, and the target layer temperature T(target), the curve may be discontinuous at Tₚₗₐₜₑₐᵤ.

As described above, the apparatus may comprise a thermal sensor 72 arranged to measure the temperature of the build area 12; and a stationary heat source 20 arranged above the build area 12 so as to heat the layer surface. The stationary heat source may be feedback controlled during the build phase 200, and at least for part of the warm up phase 100, for example during the layering phase 100_2 of the warm up phase 100, based on measurements by the thermal sensor 72 over all or part of the build area 12. These measurements may capture the temperature of the entire build area 12 following a specific step of the cycle. During the non-layering phase, the stationary heat source 20 may be feedback controlled based on measurements of the build material temperature within the dosing chamber, measured by for example the thermal sensors 74, 76 of FIGS. 3 and 4; alternatively, it may be operated at a predetermined input power. The cycle of the build phase 200 may thus further comprise: measuring the temperature of the build area 12 using the thermal sensor 72 or of the build material within the dosing chamber 40, 60, and operating the stationary heat source 20 in response to the measured temperature and with respect to the target layer temperature T(target), wherein the target layer temperature is between the glass transition or the solidification temperature and the melting temperature of the build material. The target layer temperature T(target) may be indicated by a plateau temperature Tₚₗₐₜₑₐᵤ as described with respect to FIG. 9. The stationary heat source 20 may in this way be operated by applying the same feedback control based on temperature measurements by the same sensor during at least the layering stage of the warm up phase and the build phase. Preferably, the stationary heat source is operated continuously during the warm up phase 100 and/or the build phase 200. In response to at least one of the measurements by the thermal sensor 72, during the layering stage 100_2 of the warm up phase 100 and/or during the build phase 200, the stationary heat source 20 may be operated to maintain the temperature of some or preferably at least a majority of the build area 12 at or near to the target layer temperature T(target).

The stationary heat source 20 shown in FIG. 2A, may comprise an array of individually addressable heater elements configured to provide individual, or zonal, thermal compensation over corresponding regions on the build area 12. In variants, and depending on the type of heat source and its mode of operation, it may be preferable to operate the third heat source 20 continuously throughout the duration of at least the layering phase of the warm up phase 100 and the build phase 200. This may mean that the stationary heat source is operated throughout each step of the cycle. Continuous operation may comprise operating each heating element of the stationary heat source 20 at respective constant or variable duty cycles. The thermal sensor 72 arranged above the build area 12 may be a thermal camera with a high-resolution pixel array configured to monitor the build area 12. A plurality of pixels may be arranged such that each of the plurality of pixels measures a temperature for a corresponding one of a plurality of locations, or zones, of the build area 12. In this way, the third heat source may be operated to provide zonal heating, by operating each heater element in response to the measurements of the one or more groups of sensor pixels. The stationary heat source may be operated intermittently, but is preferably operated continuously during the layer cycle of the warm up process in response to temperature measurements by the thermal sensor 72. Continuous operation of any of the heat sources may comprise operating a heat source at a predefined power input over the duration of their operation. Preferably, the first and second heat source L1, L2 are operated continuously during their movement over the build area 12.

Further heat may be input to the build material during the warm up phase 100 by operating the same one or more moveable heat sources L1, L2 that are used during the build phase 200 for preheating and fusing. The warm up phase may comprise, in variants of the method, as part of step (b) at block 104: a step (b2) of heating following pushing the dosed amount by passing a moveable preheat source L1 and/or a moveable fuse source L2 across the build area 12, as illustrated in FIGS. 2A and 2B, while operating the moveable preheat and/or fuse source. The power input to at least one of the one or more moveable heat sources L1, L2 may be feedback controlled based on measurements by one of the thermal sensors 72, 74, 76 and for example the plateau temperature Tₚₗₐₜₑₐᵤ during the layering stage and/or the non-layering stage of the warm up phase; or based on non-layering target temperate T_{NLS} during the non-layering stage. In case of a print and sinter apparatus, to form an object during the build phase 200, the step at block 208 of selectively fusing an object specific region within the build area 12 so as to form a cross section of the object may comprise: depositing radiation absorber over a layer specific region 50 comprised within the build area 12; and heating by passing the moveable fusing heat source L2 across the build area while operating the moveable fusing heat source L2 so as to melt the build material within the layer specific region 50.

Calibration Routines

The layering stage 100_2 of the warm up phase 100 may be utilised to carry out certain calibration routines to optimise the thermal performance of the various thermal components contributing the heating and thermal control of the system. For example, the layering stage 100_2 of the warm up phase 100 may further comprises a step equivalent to block 208 of the build phase so as form one or more test objects used to calibrate one or more thermal components. The thermal components may be any of the components contributing to the thermal cycle, and may for example comprise any of the radiative heat sources such as the moveable heat sources L1, L2, and the stationary heat source 20, and the one or more thermal sensors 72, 74, 76. The intermediate layering stage 100_2 may thus comprise one or more calibration routines for at least one thermal control component of the apparatus, each routine comprising measuring the temperature of at least the one or more test objects at least once following heating so as to form a cross section of a test object; determining a calibration outcome based on the one or more measurements; and applying the calibration outcome to the operation of the thermal control component for subsequent layers of the layering phase 100_2 and/or the build phase 200. The calibration outcome may be one or more of a calibrated power output of the one or more heat sources, and a calibrated measurement accuracy of the one or more thermal sensors. For some calibration routines, forming the test object may comprise depositing absorption modifier in form of absorption inhibitor over a surrounding area surrounding the layer-specific region and/or radiation absorber over the layer-specific region, such that the step of heating the layer causes the build material of the object specific region to melt or sinter while the surrounding area does not melt or sinter.

Thermal Cycle

As described above, in the method described herein or any of its variants, the step (c) at block 204 of the build phase 200 may comprise a sub-step of heating the formed layer by passing the moveable preheat source L1 across the build area 12 while operating the moveable preheat source L2, so as to preheat the formed layer to a temperature below the melting temperature of the build material and above a solidification temperature of the build material. The input power profile of the one or more moveable heat sources L1, L2 may be a constant input power profile, for example a constant duty cycle, such that the energy of heating is constant along the first direction over the build area 12 as the heat source passes at constant speed. In variants of the method, the input power profile of at least one of the heat sources may vary along the direction of constant speed movement, i.e. it may vary with distance covered over the build area 12. Additionally, or instead, the power input may be varied in response to the measured temperature of one of the sensors 72, 74, 76 over different variants of the cycle of the warm up phase. Alternatively, the power input to the moveable heat sources may be different during the non-layering phase 100_1 compared to the layering phase 100_2 of the warm up phase 100. In a further way of increasing the temperature of the system and of the dosed amount, an extraction gas flow through the apparatus applied by passing a flow of gas through the space above the working surface may be lowered or is not applied during at least part of the warm up phase compared to the build phase, for example it may be lowered or switched off entirely during the non-layering phase 100_1 of the warm up phase and returned to a build phase flow state thereafter.

Preferably, the general shape of the thermal cycle defined by the thermal effect of the various heat sources on the build area, comprising the thermal effect over time due to the action and movement of the heat source(s) and the distributor, is achieved substantially in the same way during at least a final layering stage of the warm up phase 100 and throughout most or substantially all of the build phase 200. For example, following a non-layering stage 100_1 applying a different thermal cycle, the thermal cycle during all or a final part of the layering stage 100_2 may have substantially the same shape, or is substantially the same, as that of the build phase 200. The shape of the thermal cycle may further be defined by the speeds and timings of the motion of the moveable heat sources and the distributor. In preferred variants, these are preferably identical for at least some of the layers of the warm up phase 100 adjacent the build layers of the build phase 200. It has been found that this provides improved consistency in and control over the quality of the built objects. The shape of the thermal cycle may further be affected by the levels of applied heat. During some or all of the warm up phase 100, one or more of the thermal components applied to heat the dosed amount may be operated differently than during the build phase, thus achieving a different shape of the thermal cycle. This may for example be the case for the non-layering stage of the warm up phase to increase the warm up rate of the build material. When the layering stage commences, some or all of the layers may be formed by applying the layer cycle such that the shape of the thermal cycle is substantially the same as that of the build phase, at least in timings of thermal events of distributing and heating by the radiative heat sources 20, L1, L2. This may be preferable where any of the layers are calibration layers for calibrating the radiative heat sources or the measurement scale of the thermal sensor 72. It has been found that this further provides improved consistency and control over the quality of the built objects.

The movement of the carriages 30_1, 30_2 in FIGS. 2A and 2B for example and the action of the various modules over the build area 12 as herein described may describe a dynamic repetitive layer cycle. Preferably, the steps of pushing the dosed amount across the build area 12 and of heating using the moveable heat sources L1, L2 area applied along the same direction and at the same speeds, such that a time interval between the thermal events of cooling following distribution of a layer, and of heating the layer, are the same at any location over the build area 12. In this way, the shape of the thermal cycle is maintained throughout the layering stage 100_2 and the build phase 200. This may be described by initiating the step distributing a layer across the build area 12 (e.g. by moving the distributor 32 to push the dosed amount across the build area to form a layer); initiating the step of preheating, where present, the newly formed layer using a heat source such as moveable preheat source L1 after a first time interval from the step of initiating distributing the layer; initiating a step of heating the formed layer using a heat source such as moveable fusing source L2 after a second time interval from the step of initiating distributing the layer; and initiating the next step of distributing after a third time interval from initiating the step of heating the formed layer; wherein the first, second and third time intervals are the same for each cycle of at least the final layer stage of the warm up phase and the build phase. In addition, the heat sources of the build phase may be operated throughout the warm up phase, during some or all of the layering stage 100_2, and where present also during some or all of a non-layering stage 100_1 of the warm up phase. A single moveable heat source L1 may be used for carrying out the preheating step, returning without being operated/heating along the second direction, and then carrying out a fusing step, or second heating step, again in the first direction. Where the apparatus has two heat separate heat sources for the two steps, for example as shown in FIGS. 2A and 2B, the two carriages may move one after the other, the second carriage 30_2 following the first carriage 30_1, along the first direction (here along x), and the first heat source L1 is used for the step (b) of heating and the second heat source L2 is used for the step (c) of heating. Other carriage arrangements may be envisaged, for example where the first and second carriage 30_1, 30_2 are reversed, to implement the method and its variants. In this case, the carriages move in the first direction, the second carriage 30_2 leading the first carriage 30_1, to carry out the fusing step at block 208 of the previous layer by the second heat source L2, followed by the distributor module (or “distributor”) 32 on the second carriage 30_2 to distribute the new layer at step (b) at block 204, and heating that layer at step (b) using the first (pre)heat source L1. Both carriages then return along the second direction with the heat sources turned off to repeat steps (c), (a), (b). In further implementations, a single carriage may support the one or more heat sources and the distributor 32 and the deposition unit 38.

Design and Control of Warm Up Phase

The controller 70 as indicated in FIG. 2A to 4 may be used to carry out part or all of the method and any of its variants described herein. The controller 70 may be arranged to control or optimise the design of a warm up phase, based on a preferred duration of a warm up phase, the starting temperature at the beginning of the warm up phase, the target layer temperature T(target) to be achieved and/or a corresponding temperature measured elsewhere along the build material path, such as the plateau temperature. Furthermore, a non-layering stage target temperature T_{NLS} may be defined for the non-layering phase. In variants, a range for T_{NLS} may be defined. For example, the target temperature T_{NLS} may be chosen from a range so as to reduce the number of layers of the layering stage, for example by selecting a relatively higher target temperature T_{NLS} for a given warm up phase such that during the layering stage, there is a relatively smaller difference between the plateau temperature Tₚₗₐₜₑₐᵤ and the target temperature T_{NLS}. The layering stage may thus be shortened in duration and fewer layers may be formed during that shortened duration, thus saving material and time. Additionally, or instead, the duration to achieve the non-layering stage target temperature T_{NLS} may be defined and the controller may be arranged to determine the heating conditions, based on boundary conditions. A boundary condition may be the maximum heating temperature that may be applied to the particulate material so as to prevent applying excessive heating that may deteriorate the quality of the build material. This may apply for example during the non-layering stage to achieve the non-layering stage target temperature T_{NLS} within the defined duration but without degrading the material that is being pushed across the build bed surface. Such considerations may lead to a minimised warm up phase duration and allows the build process to start without delay. Thus a controller may be provided, wherein the controller is configured to: determine one or more properties of the warm up phase based on a predefined duration over which the warm up phase is to be applied to achieve steady thermal state. The steady thermal state may be indicated by the plateau temperature Tₚₗₐₜₑₐᵤ determined from temperature measurements by the dosing chamber wall sensor 74 or the remote sensor 76. The one or more properties may comprise one or more of: (i) a duration of a non-layering stage versus a duration of a layering stage of the warm up phase; (ii) one or more calibration layers for one or more calibration routines of a thermal component during the layering stage of the warm up phase; (iii) the speed at which one or more of the one or more moveable heat sources L1, L2 and the build material distributor 32 are passed and/or returned over the build area during any of the cycles of the warm up phase; (iv) a non-layering stage target temperature T_{NLS} of the non-layering phase of the warm up phase, determined from measurements made by the dosing chamber wall sensor 74 or the remote sensor 76; and (v) a duty cycle of the one or more radiative heat sources, which may be one or more of the stationary overhead heater 20 and the first and second moveable heat source L1, L2. Optionally, the controller may be configured to determine a different thermal cycle to be applied during a first duration of the warm up phase, and determine a second duration, applied over at least part of the layering stage of the warm up phase, and over which warm up layers are processed according to the thermal cycle of the subsequent build phase. In addition, the shape of the thermal cycle over the second duration may be substantially the same as that of the subsequent build phase.

The controller may further be configured to monitor a temperature of the build material path and determine, from the monitored temperature, that the non-layering stage target temperature T_{NLS} of the non-layering phase has been achieved and initiate the layering stage of the warm up phase; and/or determine, from the monitored temperature, that the plateau temperature Tₚₗₐₜₑₐᵤ has been achieved and initiate the build phase based on the determination that the plateau temperature Tₚₗₐₜₑₐᵤ has been achieved. This may comprise initiating one or more final warm up layers to be processed before progressing to the build stage.

The melting temperature of the build material may be defined in terms of the onset of melting, Tm_onset, and the solidification temperature may be defined by the onset of solidification or by the onset of crystallisation, Tc_onset, for example as may be determined by the method prescribed in ISO 11357-1 (2009). The difference between Tm and Tc is typically larger than the difference in Tm_onset and Tc_onset and may define a more suitable sinterability window within which the target layer temperature may be defined. The target layer temperature may represent the target steady state for the build process.

I/We claim:

1. A method of operation for an apparatus for the layerwise manufacture of 3D objects from particulate material, the apparatus including a build area arranged between a dosing device side and a receiving chamber side, a dosing device at the dosing device side configured to dose an amount of build material onto a work surface including the build area, a receiving chamber configured to receive at least a portion of the dosed amount and to return the portion to the dosing device, a build material distributor configured to transfer the dosed amount across the build area to form a layer and/or to push the portion of build material into the receiving chamber, and one or more heat sources configured to heat particulate build material; the method comprising a warm up phase followed by a build phase for one or more 3D objects, the warm up phase and the build phase further comprising a cycle of the steps of:
(a) dosing the amount of build material from the dosing device onto the work surface;
(b) pushing at least a portion of the dosed amount across the build area from the dosing device side to the receiving chamber side of the build area and into the receiving chamber by passing the build material distributor over the build area;
(c) heating the dosed amount, by operating the one or more heat sources, at one or both of steps (a) and (b);
wherein the steps (a) to (c) are repeated until each phase is complete;
wherein the build phase further comprises at step (b): forming a layer over the build area from a layer portion of the dosed amount while pushing the dosed amount over the build area, and at step (c) a step of selectively melting the build material within a layer-specific region defined within the build area by operating a fusing heat source of the one of the one or more heat sources;
wherein, over a given duration of time, an aggregate volume of the portions of build material pushed into the receiving chamber during the warm up phase is larger than an aggregate volume of the portions of build material pushed into the receiving chamber during the build phase.

2. The method of claim 1, wherein the step (c) further comprises one or both of heating the build material in the dosing device at step (a) and heating the portion of the dosed amount at step (b);
optionally wherein the step of heating the build material in the dosing device at step (a) includes one or more of:
(i) heating a wall of the dosing device so as to heat the build material inside the dosing device;
(ii) operating a heat source arranged at least intermittently above the dosing device, wherein the dosing device is arranged below the work surface and includes an opening to the work surface, the heat source radiating through the opening at least intermittently; and
(iii) heating at least part of a build material path between the receiving chamber and the dosing device so as to heat the portion of build material as it is being returned to the dosing device.

3. The method of claim 2, wherein the step of heating the portion of the dosed amount at step (b) further comprises heating the build area by one or more of:
(i) operating a stationary heat source arranged above the build area;
(ii) operating one or more moveable heat sources while passing the one or more moveable heat sources across the build area; and
(iii) operating a heater arranged below the build area so as to heat the build area.

4. The method of claim 3, comprising step (ii) wherein at least one of:
providing a heat output of the heat source that is different during the warm up phase compared to the build phase; and
wherein the steps of pushing and operating the one or more moveable heat sources while passing are carried out in the same direction across the build area.

5. The method of claim 3, further comprising, during the warm up phase: measuring a temperature of the build material in the dosing device; heating the build area in response to the measured temperature and with respect to a target temperature; and completing the warm up phase upon determining that the target temperature is reached;
optionally wherein measuring the temperature comprises: sensing a wall temperature of the dosing device; or measuring the surface of the build material within the dosing device using a pyrometer arranged to view the surface of the build material at least intermittently.

6. The method of claim 1, wherein step (b) further comprises returning the build material distributor to the dosing device side.

7. The method of claim 6, comprising one or both of heating the build material distributor so as to heat the portion of build material and operating a moveable heat source of the one or more heat sources, wherein the moveable heat source is arranged to pass across the build area ahead of the distributor and arranged to irradiate the portion of build material, as it is being pushed across the build area.

8. The method of claim 1, wherein compared to the build phase, the warm up phase comprises dosing a dosed amount at step (a) larger in volume; and/or pushing the portion of build material across the build area during step (b) at a higher speed, such that over the given duration of time, the aggregate volume of build material pushed into the receiving chamber during the warm up phase is larger compared to the aggregate volume of build material pushed into the receiving chamber during the build phase.

9. The method of claim 1, wherein at least during the build phase, each layer is formed by, before step (b): lowering the build area by a build distance to form a build recess within the work surface, such that a build layer portion of the dosed amount fills the build recess to form the layer of a build thickness defined by the build distance, and wherein for the warm up phase, compared to the build phase, a warm up layer formed over the build area at step (b) is thinner than the build layer formed during the build phase.

10. The method of claim 1, wherein during the build phase, each layer is formed by, before step (b): lowering the build area by a build distance to form a build recess within the work surface, such that a build layer portion of the dosed amount fills the build recess to form the layer of a build thickness defined by the build distance, and wherein the warm up phase comprises a non-layering stage during which the build area is not lowered before step (b) and such that substantially no layer of build material is formed from the dosed amount and the portion of build material pushed into the receiving chamber is substantially the dosed amount.

11. The method of claim 10, wherein the warm up phase further comprises a layering stage following the non-layering stage, wherein the layering stage comprises, before step (b): lowering the build area by a warm up distance to form a warm up recess within the work surface, such that a warm up layer portion of the dosed amount fills the warm up recess to form the layer of a thickness defined by the warm up distance.

12. The method of claim 11, wherein the warm up distance is the same as the build distance such that the warm up layer portion is the same as the build layer portion, and optionally wherein one or both of the dosed amount during the warm up phase is larger than the dosed amount during the build phase; and the speed of pushing the dosed amount over the build area is larger during the warm up phase than during the build phase.

13. The method of claim 11, wherein the apparatus comprises a thermal sensor arranged to measure a temperature of the build area; and wherein a stationary heat source of the one or more heat sources is arranged above the build area so as to heat the layer surface; wherein the cycle of the build phase further comprises, measuring the temperature of the build area, and operating the stationary heat source in response to the measured temperature and with respect to a target layer temperature, wherein the target layer temperature is between the solidification temperature and the melting temperature of the build material.

14. The method of claim 1, wherein the warm up phase is complete after a predetermined number of cycles.

15. The method of claim 13, comprising heating the build area continuously during the warm up phase and the build phase by continuously operating the stationary heat source.

16. The method of claim 1, wherein the step (c) of the build phase comprises, following forming the layer and before the step of heating so as to selectively melt the build material within the layer-specific region, depositing absorption modifier over the layer-specific region or an area surrounding the layer-specific region; and wherein the step of heating to selectively melt comprises: passing while operating a moveable fuse source across the build area.

17. The method of claim 16 wherein the warm up phase is complete after a predetermined number of cycles, and wherein the layering stage of the warm up phase further comprises the step (c) of the build phase so as form one or more test objects.

18. The method of claim 17, wherein the layering stage comprises one or more calibration routines for at least one thermal control component of the apparatus, comprising measuring the temperature of at least the one or more test objects at least once during the cycle following the step of heating using the fuse source; determining a calibration outcome based on the measurements; and applying the calibration outcome to the operation of the thermal control component for subsequent layers.

19. A controller configured to determine a property of a warm up phase for an apparatus for the layerwise manufacture of 3D objects from build material according to claim 1, wherein the controller is configured to determine a property of the warm up phase based on a predefined duration over which the warm up phase is to be applied to achieve an operational steady thermal state for the build phase, wherein the property comprises one or more of:
(i) a duration of a non-layering stage of the warm up phase, during which no layers are formed, versus a duration of a layering stage of the warm up phase, during which layers are formed;
(ii) one or more calibration layers for one or more calibration routines of a thermal component during the layering stage of the warm up phase;
(iii) a speed at which a moveable heat source, configured to contribute to the step of heating, and a distributor, configured to provide the step of transferring the build material, are passed and/or returned over the build area during any of the cycles of the warm up phase;
(iv) a non-layering stage target temperature T_{NLS} of the non-layering stage of the warm up phase; and
(v) a duty cycle of a radiative heat source configured to contribute to the step of heating, optionally wherein the radiative heat source comprises the moveable heat sources.

20. The controller of claim 19, further configured to at least one of:
determine a first duration of the warm up phase during which a first layer cycle is to be applied, and determine a second duration for at least part of the layering stage of the warm up phase over which a second cycle is to be applied, wherein the second cycle is the same as that of the subsequent build phase; and
to monitor a temperature of the build material path, and to determine, from the monitored temperature, that: the non-layering stage target temperature T_{NLS} of the non-layering phase has been achieved and initiate the layering stage of the warm up phase; or that a steady temperature Tₚₗₐₜₑₐᵤ has been achieved and initiate the build phase based on the determination.
